(19) United States
(12) Patent Application Publication
(10) Pub. No.: US 2026/0125252 A1
(43) Pub. Date: May 7, 2026

(54) LIFT DEVICE AND WELD SPLATTER REMOVAL SYSTEM FOR THE LIFT DEVICE

(71) Applicant: TEREX SOUTH DAKOTA, INC., Watertown, SD (US)

(72) Inventor: Jorge CAVAZOS GARCIA, Monterrey (MX)

(21) Appl. No.: 18/936,056

(22) Filed: Nov. 4, 2024

(51) Int. Cl. B66F 9/065; B66F 9/075

(52) U.S. Cl. CPC B66F 9/0655; B66F 9/07504

(57) ABSTRACT

A weld splatter removal system for a boom includes at least one wear pad and at least one scraper. The at least one wear pad is securable to one of an outer boom and an inner boom. The at least one scraper is secured to each wear pad of the at least one wear pad. The at least one scraper is operable to contact a surface of the other of the outer boom and the inner boom and remove weld splatter from the surface in response to extending and retracting the inner boom with respect to the outer boom.

### TECHNICAL FIELD

The disclosure relates to lift devices that are operable to handle materials, elevate work platforms, etc.

### BACKGROUND

Lift devices may include material handlers, platforms, or other components that may be elevated relative to a corresponding base structure.

### SUMMARY

A lift device includes a chassis and a boom assembly. The boom assembly is movably secured to the chassis. The boom assembly includes a first telescopic boom, a second telescopic boom, wear pads, and scrapers. The second telescopic boom is disposed within the first telescopic boom. The wear pads are disposed between the first and second telescopic booms. The scrapers are disposed on the wear pads and are operable to remove weld splatter from a surface of one of the first and second telescopic booms in response to extending and retracting the second telescopic boom with respect to the first telescopic boom.

A weld splatter removal system for a boom includes at least one wear pad and at least one scraper. The at least one wear pad is securable to one of an outer boom and an inner boom. The at least one scraper is secured to each wear pad of the at least one wear pad. The at least one scraper is operable to contact a surface of the other of the outer boom and the inner boom and remove weld splatter from the surface in response to extending and retracting the inner boom with respect to the outer boom.

A method of removing weld splatter from a boom system includes securing an auxiliary wear pad having a scraper secured thereto to one of an inner boom and an outer boom at a location that is between the inner boom and the outer boom such that the scraper contacts a surface of the other of the inner boom and the outer boom. The method further includes extending and retracting the inner boom relative to the outer boom such that the scraper scrapes the surface of the other of the inner boom and the outer boom removing the weld splatter therefrom.

### BRIEF DESCRIPTION OF THE DRAWINGS

FIG. 1 is a perspective view of a lift device having a boom assembly with the boom assembly in a retracted and down position;

FIG. 2 is a perspective view of the lift device with the boom assembly in an extended and up position;

FIG. 3 is a cross-sectional view of the boom assembly taken along line 3-3 in FIG. 1 with primary wear pads attached to the boom assembly;

FIG. 4 is a cross-sectional view of the boom assembly taken along line 3-3 in FIG. 1 with secondary or auxiliary wear pads are attached to the boom assembly;

FIG. 5 is a top view of the secondary or auxiliary wear pads; and

FIG. 6 is a flowchart of a method for removing weld splatter from the boom assembly.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

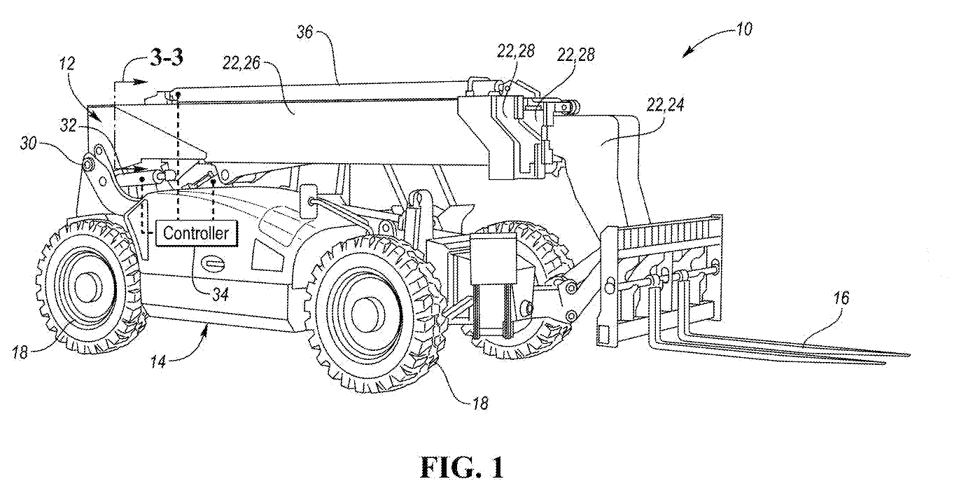

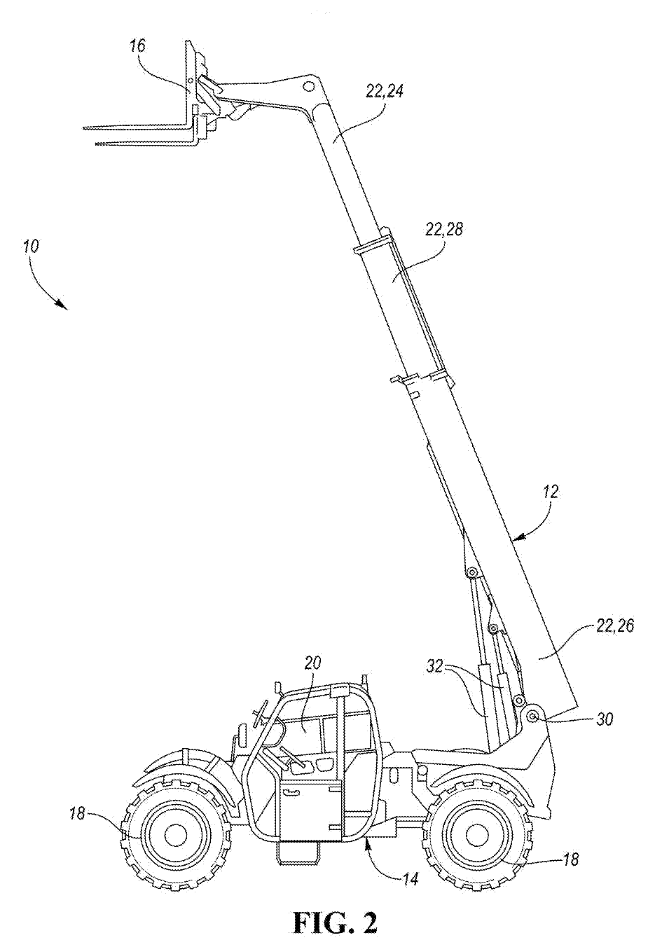

Referring to FIGS. 1 and 2, a lift device 10 is illustrated. The lift device 10 may be a land vehicle, and is depicted as a telehandler. The lift device 10 has a boom assembly 12 that is movably secured to a chassis 14. More specifically, the boom assembly 12 may be pivotably or rotatably secured to the chassis 14. Tooling 16 may be secured to an opposing end of the boom assembly 12 relative to the chassis 14. The tooling 16 may comprise one or more tools that are operable to handle materials and other various loads. For example, the tooling 16 may comprise a fork that is operable to engage and handle materials or other loads. The tooling 16 may be raised or lowered relative to the chassis 14 via the boom assembly 12.

Alternatively, a mobile platform may be secured to the opposing end of the boom assembly 12 relative to the chassis 14. Such a mobile platform may be raised or lowered relative to the chassis 14 via the boom assembly 12.

The lift device 10 is configured for lifting a load, such as a person, tools, cargo, and the like, with respect to an underlying support surface, such as paved or unpaved ground, a road, an apron such as a sidewalk or parking lot, an interior or exterior floor of a structure, or other surfaces. Traction devices, such as wheels 18, support the lift device 10 on the underlying surface. The wheels 18 may be propelled by a power generating device such as an internal combustion engine or an electric motor. The lift device 10 may include a cockpit or a cabin 20 that includes a seat for an operator and various controls to operate the lift device 10. Such various controls may include various user interfaces for controlling the lift device. For example, the controls may include an accelerator pedal to accelerate the lift device 10; a brake pedal to slow the lift device 10; a steering wheel to turn the wheels 18 to steer the lift device 10 toward a desired direction; touchscreens, control buttons, knobs, levers, dials, or any other user interface to raise and lower the boom assembly 12; and touchscreens, control buttons, knobs, levers, dials, or any other user interface to extend and retract the boom assembly 12).

The boom assembly 12 may be telescopic and may include a series of telescopic tubes, telescopic extensions, or telescopic booms 22 that extend from each other and retract into each other. The boom assembly 12 includes at least two telescopic booms 22 that are arranged from an innermost boom 24 to an outermost boom 26. If the boom assembly 12 has three or more telescopic booms 22, intermediate booms 28 will be arranged between the innermost boom 24 and the outermost boom 26. Each telescopic boom 22 may be referred to as an inner or internal boom or may be referred to as outer or external boom relative to each of the other telescopic booms 22 based on relative positions. For example, the outermost boom 26 may be an outer or external boom relative to the innermost boom 24 and each of the intermediate booms 28; the innermost boom 24 may be an inner or internal boom relative to the outermost boom 26 and each of the intermediate booms 28; each intermediate boom may be an inner or internal boom relative to the outermost boom 26; and each intermediate boom may be an outer or external boom relative to the innermost boom 24. Furthermore, if a first of the telescopic booms 22 is disposed within a second of the telescopic booms 22, then the first of the telescopic booms 22 will be referred to as the inner or internal boom while the second of the telescopic booms 22 will be referred to an outer or external boom when relating the first and second of the telescopic booms 22 to each other.

The boom assembly 12 is illustrated in a retracted and down position in FIG. 1. The boom assembly 12 is illustrated in an extended and up position in FIG. 2. The boom assembly 12 may be configured to pivot upward and downward relative to the chassis 14 along pin 30. One or more actuators 32 may be configured to pivot the boom assembly 12 relative to the chassis 14. The one or more actuators 32 may be electrical (e.g., electrical motors or cylinders operated by an electrical solenoid), hydraulic (e.g., hydraulic cylinders operated by opening and closing hydraulic valves), pneumatic (e.g., pneumatic cylinders operated by opening and closing pneumatic valves), or any other actuator known by a person of ordinary skill in the art. One or more user interfaces (e.g., touchscreens, control buttons, knobs, levers, dials, or any other user interface know in the art), which may be disposed in the cabin 20, may directly operate the one or more actuators 32 or may send a signal to a controller 34, which in turn operates the one or more actuators.

The telescopic booms 22 of the boom assembly 12 may be configured to extend from and retract into each other. One or more actuators 36 may be configured to extend and retract the telescopic booms 22. The one or more actuators 36 may be electrical (e.g., electrical motors or cylinders operated by an electrical solenoid), hydraulic (e.g., hydraulic cylinders operated by opening and closing hydraulic valves), pneumatic (e.g., pneumatic cylinders operated by opening and closing pneumatic valves), or any other actuator known by a person of ordinary skill in the art. One or more user interfaces (e.g., touchscreens, control buttons, knobs, levers, dials, or any other user interface know in the art), which may be disposed in the cabin 20, may directly operate the one or more actuators 36 or may send a signal to the controller 34, which in turn operates the one or more actuators.

While illustrated as one controller, the controller 34 may be part of a larger control system and may be controlled by various other controllers throughout the lift device 10. It should therefore be understood that the controller 34 and one or more other controllers can collectively be referred to as a “controller” that controls various actuators in response to signals from various sensors to control functions of the lift device 10. The controller 34 may include a microprocessor or central processing unit (CPU) in communication with various types of computer readable storage devices or media (e.g., a non-transitory computer readable medium having instructions stored thereon). Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the lift device 10 or the subsystems of the lift device 10.

Control logic or functions performed by the controller 34 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based controller, such as controller 34. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the lift device 10 or its subsystems. The computer-readable storage devices or media may include one or more of a number of known physical devices which utilize electric, magnetic, and/or optical storage to keep executable instructions and associated calibration information, operating variables, and the like.

In various examples, the lift device 10 may be provided as a utility vehicle with a mobile work platform assembly such as an aerial work platform, a rough terrain telescopic load handler, portable material lift, telehandler, scissor lift, telescopic and articulating boom, and the like.

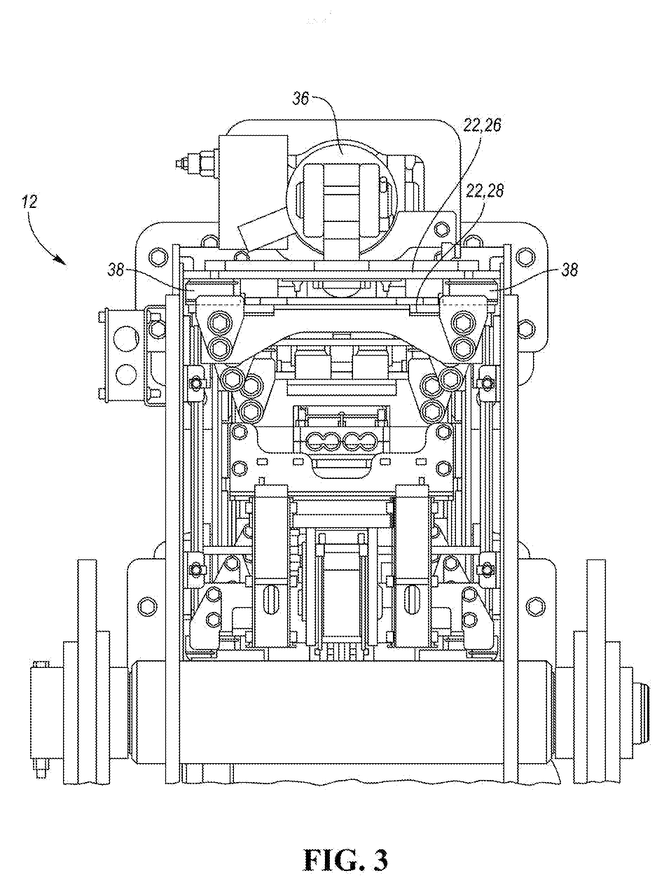

Referring to FIG. 3, a cross-section the boom assembly 12 having primary wear pads 38 secured thereto is illustrated. The primary wear pads 38 are disposed between adjacent telescopic booms 22. The primary wear pads 38 are secured to a first of the adjacent telescopic booms 22 and are configured to engage a second of the adjacent telescopic booms 22. The primary wear pads 38 may be comprised of a material that is softer than the telescopic booms 22 such that the primary wear pads 38 are configured to wear out as opposed to the telescopic booms 22 due to the friction between the primary wear pads 38 and the second of the adjacent telescopic booms 22 caused by relative linear or sliding movement between the adjacent telescopic booms 22. For example, the primary wear pads 38 may be made from a soft metal (e.g., brass or bronze) or plastic while the telescopic booms 22 may be made from a harder material (e.g., steel).

The primary wear pads 38 are illustrated as being secured to an inner boom of the adjacent telescopic booms 22 and in engagement with an outer boom of the adjacent telescopic booms 22. However, the configuration could be reversed with the primary wear pads 38 being secured to the outer boom of the adjacent telescopic booms 22 and in engagement with the inner boom of the adjacent telescopic booms 22. Furthermore, the boom assembly 12 may include additional primary wear pads 38 such that primary wear pads 38 are disposed between each adjacent telescopic boom 22 extending from the innermost boom 24, to the intermediate booms 28, and then to outermost boom 26.

During the manufacturing process, undesired weld splatter may be deposited on the telescopic booms 22 in the vicinity of the wear pads 38, which could lead to damaging the wear pads 38 during operation of the boom assembly 12. Therefore, it is desirable to remove such weld splatter. It is noted that each instance of the term splatter herein may also or alternatively refer to spatter. The current method utilized for cleaning weld splatter from a boom assembly is a manual process that includes using a spatula. This method is used when the booms are not assembled and is not efficient due to the time required to remove the weld splatter by hand. It is also difficult to reach all the areas where weld splatter may exist. Currently, there are no other methods for removing weld splatter from the wear pad areas from assembled booms either at the factory or in the field. Furthermore, removing weld splatter from assembled booms with a spatula, requires disassembling the booms, which further reduces efficiency.

The purpose of this disclosure is to provide a system for removing undesired weld splatter from booms. The system may be used when the booms are assembled at the factory or may be used while the booms are being utilized in the field. The advantage of the system of this disclosure is the effectiveness of the system to reach all the desired areas to remove the weld splatter and the decrease in effort required to remove all the undesired weld splatter. For example, the system includes placing scrapers at the same position as the primary wear pads 38 and cycling the scrapers through the same range of travel as the primary wear pads 38 to remove the weld splatter, which ensures that the weld splatter is removed from the range of travel of the primary wear pads 38 ensuring that the primary wear pads 38 do not come into contact with any weld splatter.

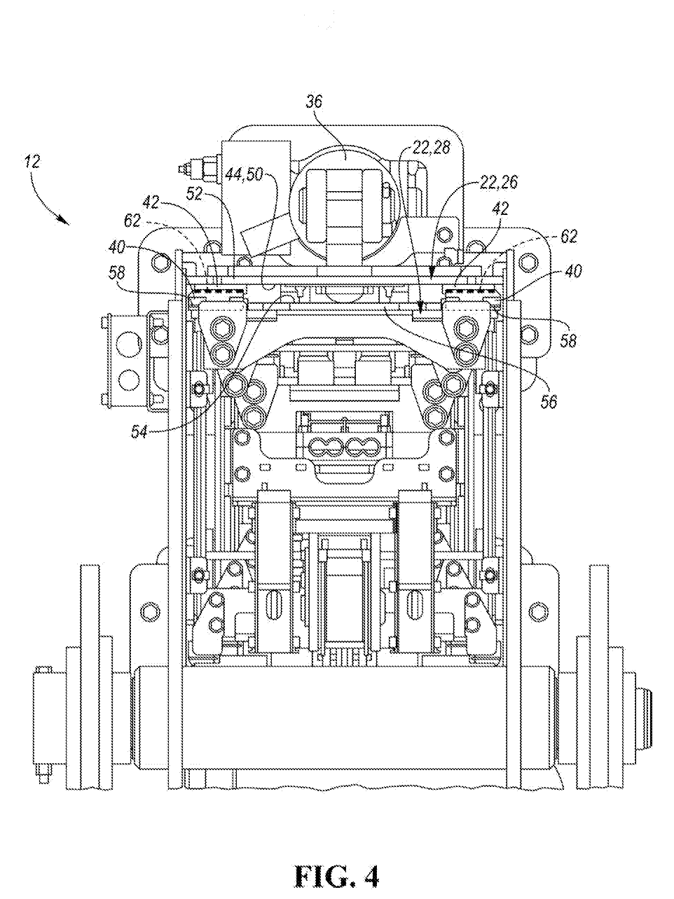

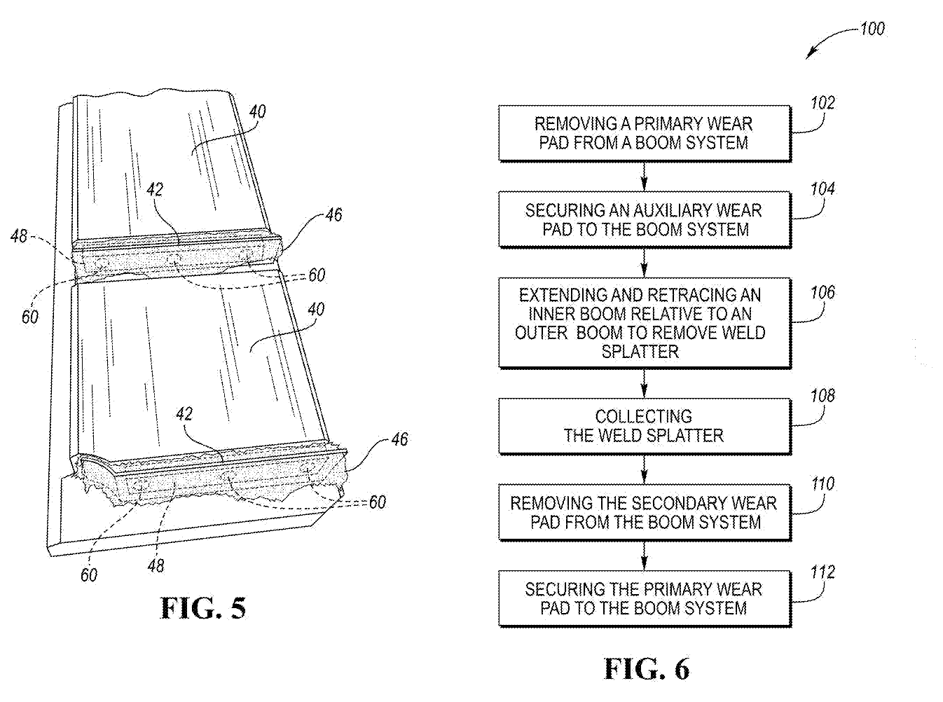

Referring to FIGS. 4 and 5, a cross-section the boom assembly 12 having secondary wear pads 40 secured thereto and a top view of the secondary wear pads 40 are illustrated, respectively. The secondary wear pads 40 are disposed between adjacent telescopic booms 22. The secondary wear pads 40 are secured to a first of the adjacent telescopic booms 22 and are configured to engage a second of the adjacent telescopic booms 22. The secondary wear pads 40 may be comprised of a material that is softer than the telescopic booms 22 such that the secondary wear pads 40 are configured to wear out as opposed to the telescopic booms 22 due to the friction between the secondary wear pads 40 and the second of the adjacent telescopic booms 22 caused by relative linear or sliding movement between the adjacent telescopic booms 22. For example, the secondary wear pads 40 may be made from a soft metal (e.g., brass or bronze) or plastic (e.g., nylon or polymer material) while the telescopic booms 22 may be made from a harder material (e.g., steel).

The secondary wear pads 40 are illustrated as being secured to an inner boom of the adjacent telescopic booms 22 and in engagement with an outer boom of the adjacent telescopic booms 22. However, the configuration could be reversed with the secondary wear pads 40 being secured to the outer boom of the adjacent telescopic booms 22 and in engagement with the inner boom of the adjacent telescopic booms 22. Furthermore, the boom assembly 12 may include additional secondary wear pads 40 such that secondary wear pads 40 are disposed between each adjacent telescopic boom 22 extending from the innermost boom 24, to the intermediate booms 28, and then to outermost boom 26.

Blades or scrapers 42 are disposed on and secured to each secondary wear pad 40. The scrapers 42 are operable to contact a surface 44 of the second of the adjacent telescopic booms 22 and remove weld splatter 46 from the surface 44 in response to extending and retracting the first or the second of the adjacent telescopic booms 22 relative to the other of the first and the second of the adjacent telescopic booms 22. The scrapers 42 may be comprised of metals (e.g., steel, brass, bronze), plastics, polymers, or any other material suitable for removing weld splatter.

Magnets 48 may be disposed on or adjacent to the secondary wear pads 40. The magnets 48 may be operable to collect the weld splatter 46 upon removal of the weld splatter 46 from the surface 44. Alternatively, an adhesive could be disposed on the secondary wear pads 40 that is operable to collect the weld splatter 46. In another alternative the weld splatter 46 could simply fall to the ground or into a receptacle due to gravity upon removal from the surface 44. The weld splatter 46 may be subsequently collected or disposed.

The surface 44 may be a lower surface 50 of an upper panel 52 of the first of the adjacent telescopic booms 22, while the secondary wear pads 40 and the scrapers 42 may be disposed on and/or secured to a top surface 54 of an upper panel 56 of the second of the adjacent telescopic booms 22. Alternatively, the surface 44 may be the top surface 54 of the upper panel 56 of the second of the adjacent telescopic booms 22 while secondary wear pads 40 and the scrapers 42 may be disposed on and/or secured to the lower surface 50 of the upper panel 52 of the first of the adjacent telescopic booms 22. The first of the adjacent telescopic booms 22 may be an outer boom while the second of the adjacent telescopic booms 22 may be an inner boom. The first of the adjacent telescopic booms 22 may more specifically be the outermost boom 26, while the second of the adjacent telescopic booms 22 is an intermediate boom 28 that is adjacent to the outermost boom 26.

Shims 58 may be disposed between the secondary wear pads 40 and the corresponding telescopic boom 22 that secondary wear pads 40 are secured to. The number of shims 58 required may be adjusted to ensure the scrapers 42 are in contact with the surface 44. Fasteners 60 may be utilized to secure the scrapers 42 to the secondary wear pads 40. Alternatively, an adhesive 62 may be utilized to secure the scrapers 42 to the secondary wear pads 40.

Referring to FIG. 6, a flowchart of a method 100 for removing the weld splatter 46 from a boom system (e.g., the boom assembly 12) is illustrated. The method 100 begins at block 102, where a primary wear pad (e.g., primary wear pad 38) is removed from one of an inner boom and an outer boom (e.g., first and second adjacent telescopic booms 22) from a location that is between the inner boom and an outer boom. Next, the method 100 moves on to block 104 where an auxiliary wear pad (secondary wear pad 40) having a scraper (e.g., scraper 42) secured thereto is secured to one of the inner boom and the outer boom at the location that is between the inner boom and the outer boom. More specifically, the auxiliary wear pad may be secured at the same position that the primary wear pad occupied before being removed at block 102. The auxiliary wear pad may be secured to one of the inner boom and the outer boom such that the scraper contacts a surface (e.g., surface 44) of the other of the inner boom and the outer boom. The step at block 102 may occur prior the step at block 104.

The step at block 104 may include disposing shims (e.g., shims 58) between the auxiliary wear pad and the boom (e.g., one of the inner boom and the outer boom) that the auxiliary wear pad is being secured to. The number of shims may be adjusted at block 104 to ensure that the scrapers are in contact with the surface (e.g., surface 44).

Next, at block 106, the inner boom is extended and retracted relative to the outer boom, or vice versa, such that the scraper scrapes the surface (e.g., surface 44) of the other of the inner boom and the outer boom removing the weld splatter therefrom. The weld splatter is then collected upon being removed from the surface at block 108. The weld splatter may be collected by magnets that are attached to the auxiliary wear pad upon removal of the weld splatter from the surface. Alternatively, an adhesive could be disposed on the auxiliary wear pad that is operable to collect the weld splatter. In another alternative, the weld splatter could simply fall to the ground due to gravity upon removal from the surface (e.g., surface 44). The weld splatter may subsequently be collected or disposed. The weld splatter could be collected in a receptacle that is disposed below the boom system during the removal process of the weld splatter.

Once the weld splatter has been removed from the boom system, the method 100 moves on to block 110 where the auxiliary wear pad and the scraper are removed from the boom. The step at block 110 may be subsequent to removing of the weld splatter from the surface (e.g., surface 44). Also at block 110, if the weld splatter was collected via an adhesive or magnets that are disposed on the auxiliary wear pad, such weld splatter may then be removed from the adhesive or magnets. The removed weld splatter may then be disposed.

Once the auxiliary wear pad has been removed at block 110, the method 100 moves on to block 112. At block 112, the primary wear pad, or other wear pad that is meant for normal operation of the boom system, is then secured to one of the inner boom and the outer boom at the location between the inner boom and the outer boom. More specifically, the primary wear pad, or other wear pad that is meant for normal operation of the boom system, may be secured at the same position that the auxiliary wear pad occupied before being removed at block 110. The step at block 112 may occur subsequent to the step at block 110.

It is noted that the steps of the method 100 may be adjusted to account for multiple primary wear pads (e.g., primary wear pads 38) and multiple auxiliary wear pads (secondary wear pad 40) having scrapers attached thereto. For example, the step at block 102 may include removing multiple primary wear pads from the boom system, the step at block 104 may include securing multiple auxiliary wear pads to the boom system, the step at block 110 may include removing multiple auxiliary wear pads from the boom system, and the step at block 112 may include securing multiple primary wear pads to the boom system.

It should be understood that the flowchart in FIG. 6 is for illustrative purposes only and that the method 100 should not be construed as limited to the flowchart in FIG. 6. Some of the steps of the method 100 may be rearranged while others may be omitted entirely.

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A lift device comprising:
a chassis; and
a boom assembly movably secured to the chassis, wherein the boom assembly includes,
a first telescopic boom,
a second telescopic boom disposed within the first telescopic boom;
wear pads disposed between the first and second telescopic booms; and
scrapers disposed on the wear pads and operable to remove weld splatter from a surface of one of the first and second telescopic booms in response to extending and retracting the second telescopic boom with respect to the first telescopic boom.

2. The lift device of claim 1 further comprising magnets disposed on the wear pads, wherein the magnets are operable to collect the weld splatter upon removal of the weld splatter from the surface.

3. The lift device of claim 1, wherein the surface is a lower surface of an upper panel of the first telescopic boom.

4. The lift device of claim 1, wherein the wear pads and scrapers are disposed on a top surface of an upper panel of the second telescopic boom.

5. The lift device of claim 1, wherein the first telescopic boom is an outermost boom of a plurality of telescopic booms.

6. The lift device of claim 1 further comprising shims disposed between the wear pads and one of the first telescopic boom and the second telescopic boom.

7. The lift device of claim 1 further comprising fasteners securing the scrapers to the wear pads.

8. A weld splatter removal system for a boom comprising:
at least one wear pad securable to one of an outer boom and an inner boom; and
at least one scraper secured to each wear pad of the at least one wear pad, wherein the at least one scraper is operable to contact a surface of the other of the outer boom and the inner boom and remove weld splatter from the surface in response to extending and retracting the inner boom with respect to the outer boom.

9. The weld splatter removal system of claim 8 further comprising at least one magnet disposed on the at least one wear pad, wherein the at least one magnet is operable to collect the weld splatter upon removal of the weld splatter from the surface.

10. The weld splatter removal system of claim 8, wherein the surface is a lower surface of an upper panel of the outer boom.

11. The weld splatter removal system of claim 8, wherein the at least one wear pad and the at least one scraper are disposed on a top surface of an upper panel of the inner boom.

12. The weld splatter removal system of claim 8 further comprising at least one shim disposable between the at least one wear pad and one of the outer boom and the inner boom.

13. The weld splatter removal system of claim 8 further comprising at least one fastener securing the at least one scraper to the at least one wear pad.

14. The weld splatter removal system of claim 8 further comprising an adhesive securing the at least one scraper to the at least one wear pad.

15. A method of removing weld splatter from a boom system comprising:
securing an auxiliary wear pad having a scraper secured thereto to one of an inner boom and an outer boom at a location that is between the inner boom and the outer boom such that the scraper contacts a surface of the other of the inner boom and the outer boom; and
extending and retracting the inner boom relative to the outer boom such that the scraper scrapes the surface of the other of the inner boom and the outer boom removing the weld splatter therefrom.

16. The method of claim 15 further comprising removing a primary wear pad from the location that is between the inner boom and the outer boom prior to securing the auxiliary wear pad to one of the inner boom and the outer boom at the location.

17. The method of claim 16 further comprising collecting the weld splatter upon removal of the weld splatter from the surface.

18. The method of claim 15 further comprising placing shims between the auxiliary wear pad and one of the inner boom and the outer boom to position the scraper such that the scraper is in contact with the surface.

19. The method of claim 15 further comprising removing the auxiliary wear pad and the scraper from the boom system subsequent to removing of the weld splatter from the surface.

20. The method of claim 19 further comprising securing the primary wear pad to one of the inner boom and the outer boom at the location subsequent to removing the auxiliary wear pad and the scraper from the boom system.
